(19) United States
(12) Patent Application Publication
(10) Pub. No.: US 2018/0134337 A1
(43) Pub. Date: May 17, 2018

(54) Bicycle seat post assembly

(71) Applicant: BARRY LYN HOLTZMAN, EAGLE RIVER, WI (US)

(72) Inventor: BARRY LYN HOLTZMAN, EAGLE RIVER, WI (US)

(21) Appl. No.: 15/530,009

(22) Filed: Nov. 16, 2016

(51) Int. Cl. B62K 19/36; B62J 1/08; F16B 7/14

(52) U.S. Cl. CPC B62K 19/36; B62J 2001/085; F16B 7/14; B62J 1/08

(57) ABSTRACT

A bicycle seat post assembly uses a detent to urge the assembly to remain in an extended position to provide a rider of the bicycle a relatively high seat height but which allows the rider to move the assembly between the extended position and a retracted position using hands-free operations. In one assembly embodiment, a second detent can hold this assembly at an intermediate position between its extended and its retracted positions absent any of the rider's weight applied to the seat, but in which the assembly can then be returned to its extended position by a sequential application and removal of a portion of the rider's weight to the seat. Therefore, this embodiment allows the rider to have a relatively high seat position, it allows him to move his seat between a relatively high position and a relatively low position, and it allows him to place the seat in an intermediate position absent any of his weight applied to the seat, all movements being performed using hands-free operations.

### CROSS REFERENCE TO RELATED APPLICATIONS

Not Applicable

### FEDERALLY SPONSORED RESEARCH OR DEVELOPMENT

Not Applicable

### SEQUENCE LISTING, TABLE, OR PROGRAM

Not Applicable

### BACKGROUND

### Field

This application relates to an apparatus which is a seat post assembly used to attach a bicycle seat to a bicycle frame which allows a rider of the bicycle to change his seat height with hands-free operations. The seat post assembly has a first portion which is fixed to the frame, a second portion, to which the seat is secured, which is slidably secured in the first portion, and one or more detents which urge the second portion to remain in one or more positions relative to the first portion, thereby providing one or more seat heights. A rider of the bicycle can adjust his seat height while riding by appropriate application and removal of forces to and from the seat.

### Prior Art

A bicycle's seat height is an important consideration in determining a rider's power and stability. In general, a relatively high seat position is desirable so the rider can develop maximum power, but a relatively low position is desirable for stability. Therefore, an ability to adjust a bicycle's seat height is beneficial, especially if the adjustment can be made while riding. Also, since many bikes have two hand-operated derailleurs and two hand-operated brakes, an apparatus which allows seat height adjustment using hands-free operations is desirable.

Bicycle seats can be attached directly to a bicycle frame, but this makes it difficult to change seat height. A seat post is therefore typically used to make the attachment. Fixed length seat posts are most common and they normally comprise a cylindrically shaped post with a seat clamp at its top to which the seat is attached. The seat post is attached to the frame by inserting its post into a tubular member of the frame called a seat tube and securing it therein by a clamping device. A fixed length seat post allows relatively easy adjustment of seat height by changing its post's insertion depth into the seat tube, but this adjustment is difficult to perform while riding. A variation on fixed length seat posts is a class of posts called suspension seat posts which are similar to fixed length seat posts but they have a suspension mechanism to reduce impacts to the rider resulting from riding on uneven terrain.

To enable a rider to change his seat height while riding, “dropper” seat post assemblies, or “droppers” for short, have been developed. A typical dropper has a first portion comprising a sleeve which is adjustably attached to a seat tube of a bike's frame and a second portion having a post, slidably inserted in the sleeve, to which the seat is attached. It also has an energy storage device, typically a metal spring or a piston and cylinder gas spring, which urges the second portion to extend upwardly from the first portion, thus urging seat movement to a higher position. It also has a locking mechanism which can lock the second portion at desired positions relative to the first portion and a hand-operated control mechanism, typically mounted to a bike's handlebar, which allows the rider to engage or disengage the locking mechanism. A dropper therefore allows the rider to extend and retract the second portion relative to the first portion to provide respectively a high or low seat position.

Several patents pertaining to dropper seat post assemblies include U.S. Pat. No. 2,644,504 to Vick, U.S. Pat. No. 6,354,557 to Walsh, U.S. Pat. No. 7,025,522 to Sicz, and U.S. Pat. No. 8,079,772 to Brennan and Throckmorton. In U.S. Pat. No. 2,644,504, for instance, a dropper post is described which comprises a post slidably inserted into a sleeve, an energy storage device which is a spring, a locking mechanism comprising a sliding bolt which engages one of several notches in the post, and a control mechanism which is a hand-operated control knob mounted to a handlebar and connected to the bolt by a cable. If a rider wants to change seat height, he uses a hand to operate the knob to disengage the bolt from its present notch, he changes the length of the dropper by applying a force to the seat which, along with a force supplied by the energy storage device, positions the dropper at a desired length. The rider then again uses a hand to operate the knob, thereby engaging the bolt in another notch to lock the seat at a different height. This hand-operated control knob, or any hand-operated control mechanism, can be problematic because the rider is otherwise using his hands for braking or changing gears. Also, control mechanisms add additional parts and complexity when mounting a dropper seat post assembly to a bicycle.

Another type of dropper seat post assembly is described in U.S. Pat. No. 5,011,174 to Ross-Clunis in which changing seat height is a hands-free operation and does not need a control mechanism. In this adjustable height seat mechanism, a first portion slidably accepts a second portion, and these two portions are prevented from relative rotation by a guide member engaged in a guide slot which has two locking slots perpendicular to it. This mechanism's seat height is locked by positioning the guide member in either locking slot, accomplished by having a rider apply a torque to the mechanism resulting from application of a force which is perpendicular to and spaced apart from an axis of the mechanism. This torque must be applied with the mechanism's first portion in a particular position relative to its second portion wherein the guide member is positioned at one of the locking slots. This operation is inherently difficult to perform, especially when riding over rough terrain wherein forces are frequently applied which try to move the second portion relative to the first portion. When the mechanism is locked, no reasonable amount of axial force, a force which is parallel with the axis of the mechanism, applied to the mechanism will cause the first portion to move relative to the second portion.

It is desirable to have a seat post assembly for a bicycle which has one or more detents to urge the seat post assembly to have one or more preferred lengths and which therefore allows a rider to perform seat height adjustments while riding using hands-free operations.

### SUMMARY

In accordance with one embodiment of an apparatus which is a seat post assembly for a bicycle, the seat post assembly has an extended position with a detent, an intermediate position with a detent, and a retracted position. The detents urge the seat post assembly to remain in their respective positions. Because the detents do not lock but merely urge the seat post assembly to have either its extended or its intermediate length, they allow a rider of the bicycle to change his seat height while riding by application and removal of forces he applies to the seat, allowing him to easily change his seat position using hands-free operations.

### DRAWINGS—FIGURES

Drawings of the present invention are as follows:

FIG. 1 shows a partially exploded view of an apparatus which is a first embodiment of a bicycle seat post assembly which uses a single detent in its operation, FIGS. 2 and 3 show assembled views of the first embodiment in an extended and a retracted position respectively, and FIGS. 4 and 5 show in cross-section the first embodiment in the positions shown in FIGS. 2 and 3 respectively. FIG. 6 shows a partially exploded view of an apparatus which is a second embodiment of a bicycle seat post assembly which uses two detents in its operation, FIGS. 7, 8, and 9 show assembled views of the second embodiment in an extended, an intermediate, and a retracted position respectively, and FIGS. 10, 11, and 12 show in cross-section the second embodiment in the positions shown in FIGS. 7, 8, and 9 respectively.

### DRAWINGS—REFERENCE NUMERALS

1 bicycle seat post assembly, first embodiment
12 axis
14 sleeve
15 bicycle frame seat tube (partial view)
16 hole in sleeve for pin
18 seat clamp
19 seat
20 post
22 plug
30 pin
32 threaded hole in pin
34 slot in post
36 hole in plug for pin
37 valve
38 o-ring for piston seal
39 groove in plug
40 ball
42 hole in plug for balls
43 hole in post for detent
44 ramp bushing
46 spring for detent
48 adjustment screw for detent
51 bicycle seat post assembly, second embodiment
60 post
62 plug
63 axial hole in plug
70 pin
72 hole in pin
74 slot in post
76 hole in plug for pin
78 energy storage device spring
80 o-ring for extended position detent
81 entrance to post
82 large diameter portion of plug
83 small diameter portion of plug
86 spring for extended position detent
88 adjustment screw for extended position detent
90 ball for intermediate position detent
92 hole in plug for balls
93 hole in post for intermediate position detent
94 ramp nut
96 spring for intermediate position detent
98 adjustment screw for intermediate position detent

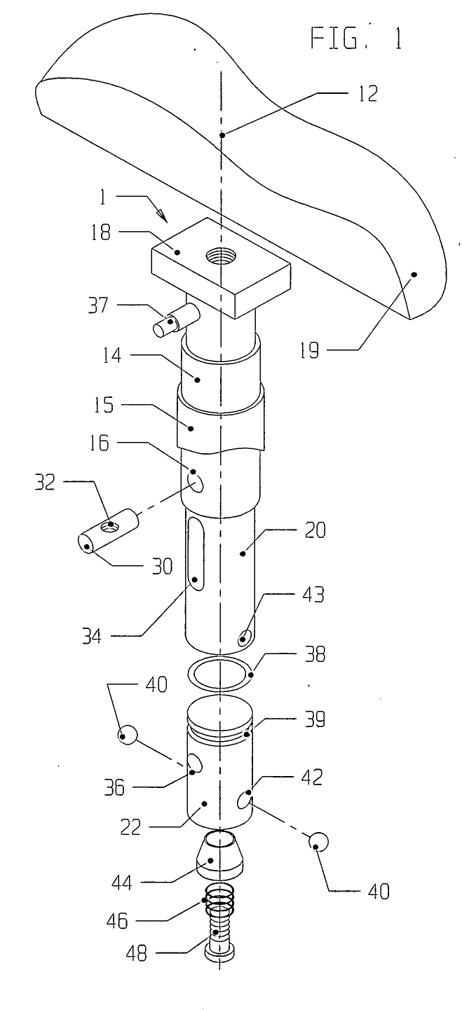

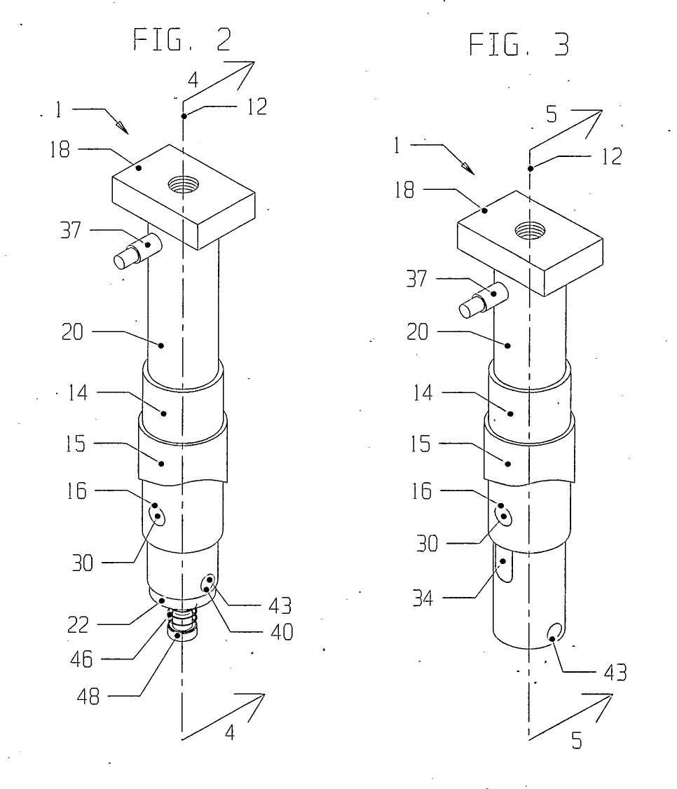

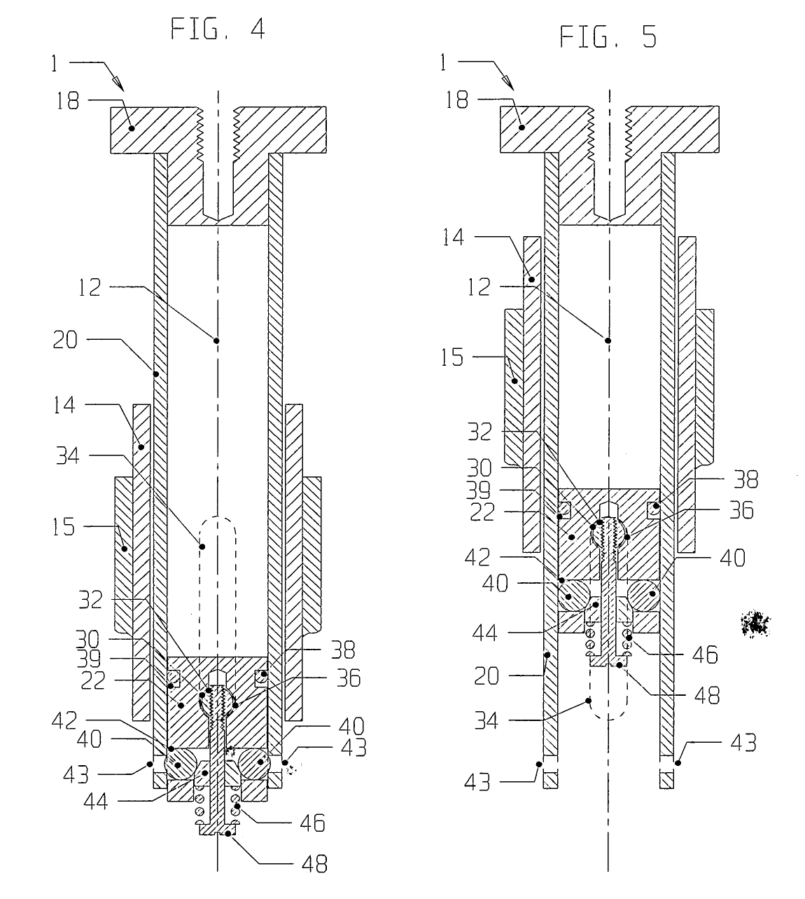

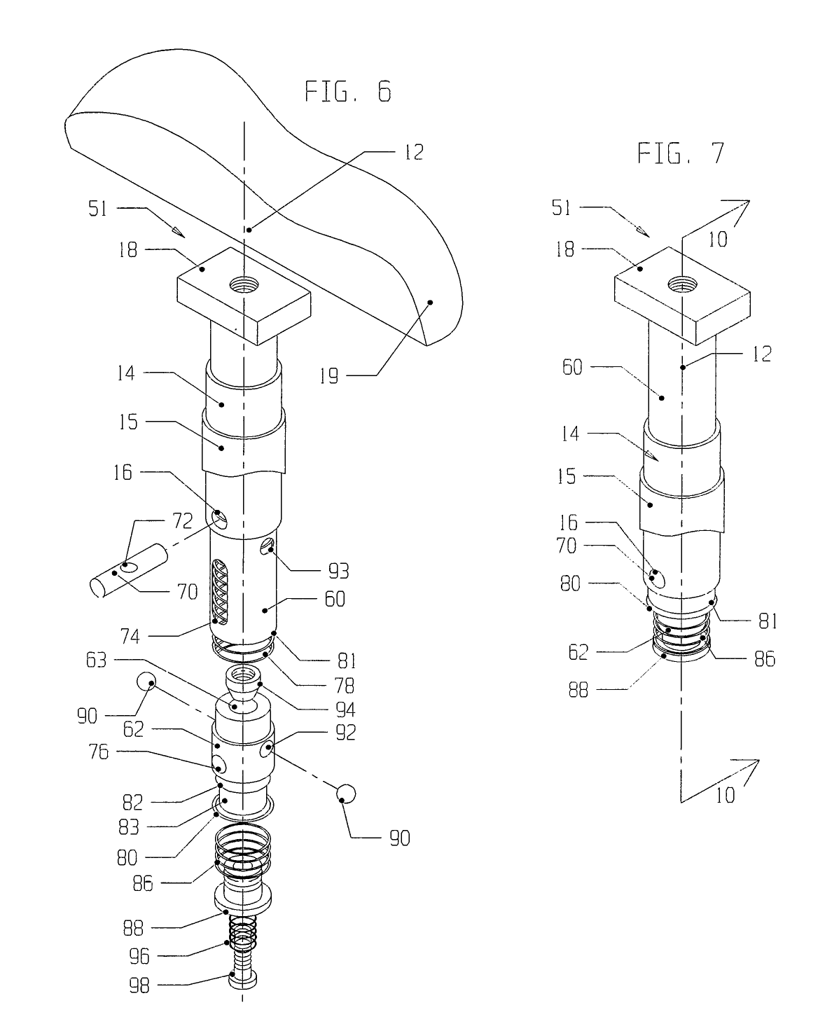

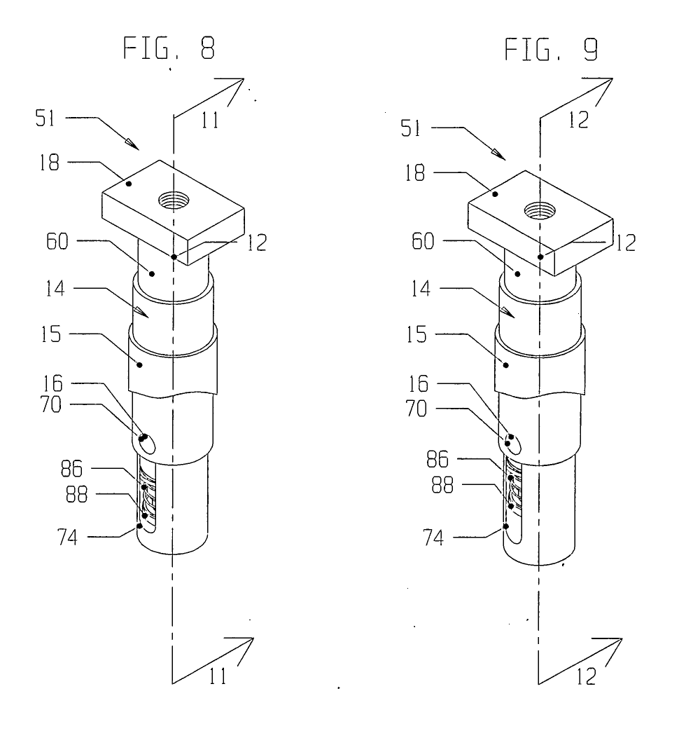

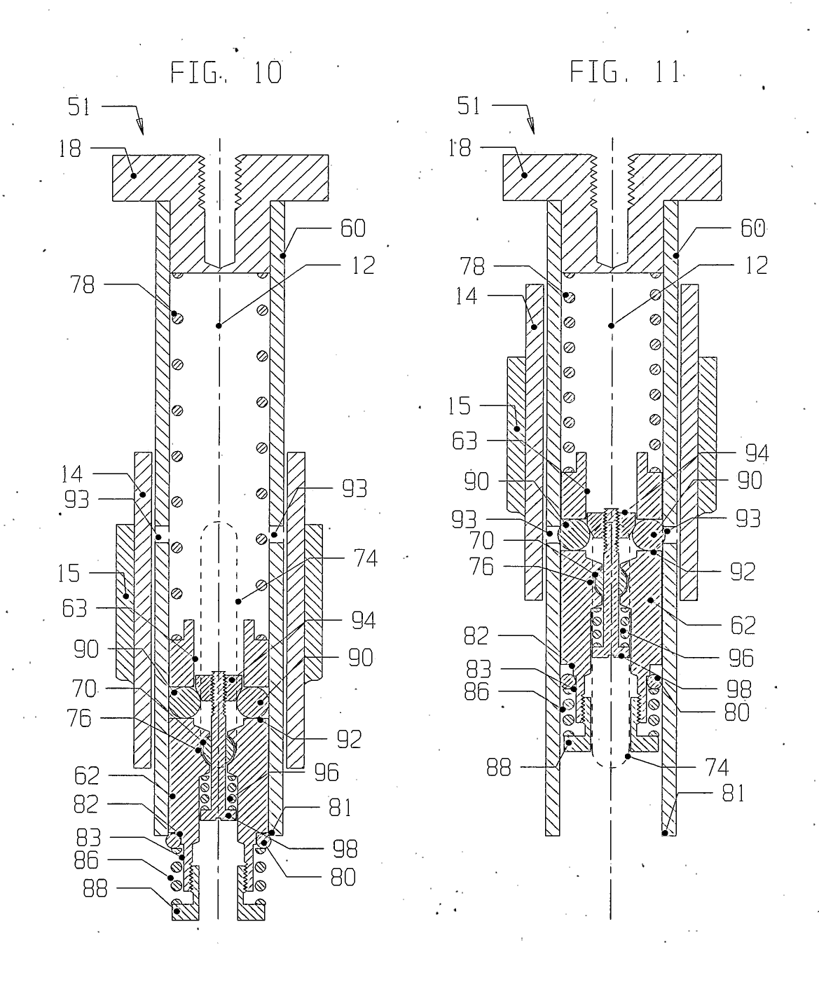

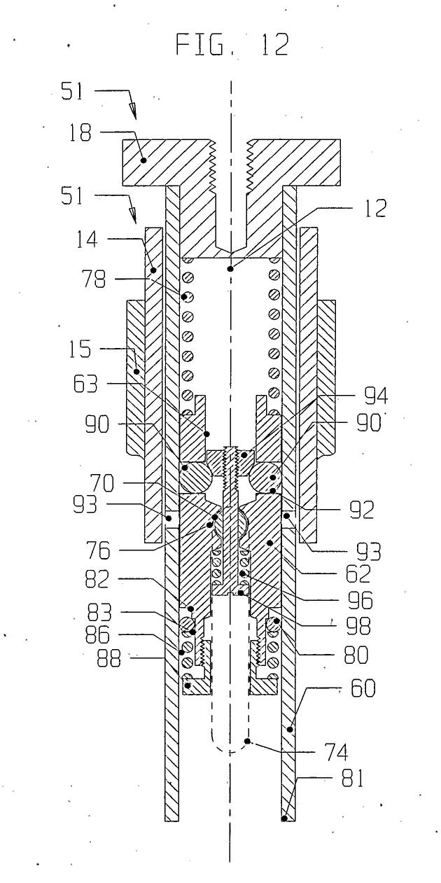

### Description—FIG. 1—Bicycle Seat Post Assembly, First Embodiment

FIG. 1 shows a partially exploded view of an apparatus which is a first embodiment of this invention, a bicycle seat post assembly 1 which has a single detent. Assembly 1 comprises the following items and features. It has an axis 12 and a sleeve 14 which can be adjustably placed in a seat tube 15 (partially shown) of a bicycle frame (not shown) and secured therein using a clamping means (not shown). Assembly 1 has a seat clamp 18, affixed to the top of a post 20, used to secure a bicycle seat 19 to the top of assembly 1. Sleeve 14 slidably accepts post 20 and post 20 slidably accepts a plug 22. With assembly 1 components properly positioned, a pin 30 with a threaded hole 32 can be passed through a hole 16 in sleeve 14, through a slot 34 in post 20, and into a hole 36 in plug 22, thereby limiting rotational and translational movement of post 20 relative to sleeve 14. A valve 37 can be used to pressurize a cylinder which is enclosed by an upper part of post 20, sealed at its top by clamp 18 and slidably sealed at its bottom by a piston which is plug 22 sealed to post 20 by an o-ring 38 placed in a groove 39 in plug 22. This cylinder, piston, and valve 37 comprise a gas spring which is an energy storage device for assembly 1. The detent of assembly 1 comprises a pair of balls 40 which travel in a hole 42 in plug 22, a pair of holes 43 (one shown) in post 20, a ramp bushing 44, a spring 46, and an adjustment screw 48.

### Operation—FIGS. 1-5—Bicycle Seat Post Assembly, First Embodiment

Bicycle seat 19, shown in FIG. 1, is not shown in FIGS. 2-5 to allow improved clarity. FIG. 2 shows bicycle seat post assembly 1 in an extended position wherein seat 19 is relatively far from sleeve 14 and seat tube 15 and FIG. 3 shows it in a retracted position wherein seat 19 is relatively near to them. FIGS. 4 and 5 are cross-sectional views of assembly 1 in the positions shown in FIGS. 2 and 3 respectively. These figures and discussions thereon provide operational details for assembly 1 which uses its detent to urge assembly 1 to remain in its extended position while allowing the rider to move assembly 1 between its positions using hands-free operations. Friction is a consideration in the operation of the detent, but other sources of friction are relatively small and therefore can be ignored in this discussion.

The energy storage device of assembly 1, the gas spring discussed above, provides a supporting force which urges post 20 to extend upwardly relative to sleeve 14 if a positive gauge pressure is in its cylinder. This urging is a product of the cylinder's area, an area enclosed by the inner diameter of post 20, times the gauge pressure in the cylinder. The urge to extend can be adjusted by how much gas, typically air, is introduced into the cylinder through valve 37, thereby adjusting the pressure in the cylinder. As post 20 retracts downwardly with respect to sleeve 14, plug 22 moves upwardly in post 20, the cylinder's volume decreases, the gauge pressure in the cylinder increases, and the urge to extend provided by the energy storage device of assembly 1 increases.

FIGS. 2 and 4 show assembly 1 in its extended position with pin 30 located at the bottom of slot 34. In this position, hole 42 in plug 22 is substantially in alignment with holes 43 in post 20. FIG. 4 shows balls 40 of the detent of assembly 1 partially inserted into and pressing against holes 43 in post 20, made possible by making holes 43 so they have a smaller diameter than that of balls 40. When balls 40 are in this position, the detent is “engaged”. Balls 40 are urged to move outwardly and press against holes 43 by ramp bushing 44 which is pushed upwardly by a compression in spring 46. Adjustment screw 48 is screwed into threaded hole 32 in pin 30, and the urging of balls 40 toward holes 43 can be adjusted by turning screw 48 to change the compression in spring 48 and hence the force it applies to ramp bushing 44.

An axial force, a force parallel with axis 12, applied to post 20 and urging it to move with respect to sleeve 14, will urge balls 40 to move inwardly along hole 42 in plug 22 and away from holes 43 against the urging of spring 46 and ramp bushing 44 which urge them to remain against holes 43. Assuming no force is supplied by the energy storage device of assembly 1, an axial force just sufficient to move balls 40 entirely within the inner diameter of post 20, thus fully “disengaging” the detent, is called the detent's “breakaway force”.

With assembly 1 in its extended position with its extended position detent engaged, assembly 1 can support a rider with an extended position supporting force which includes a supporting force provided by its energy storage device when assembly 1 is in its extended position and the breakaway force provided by the detent. A rider normally has a portion of his weight supported apart from seat 19. For instance, his arms are at least partially supported by a handlebar and his feet and legs are at least partially supported by a pair of pedals. An extended position supporting force which is less than the rider's total weight is therefore satisfactory for operation of assembly 1. An extended position supporting force which is approximately 50-65% of the rider's weight works well in preventing unwanted disengagement of the detent while allowing the rider to apply reasonable downward force to seat 19 to overcome the extended position supporting force, disengage the detent, and lower seat 19. Adjustment of the extended position supporting force of assembly 1 can be accomplished primarily in a couple of ways. Firstly, the supporting force provided by its energy storage device can be adjusted by changing the pressure in the gas spring's cylinder. Secondly, the detent's breakaway force can be adjusted by turning screw 48 to change the force applied by spring 46 to ramp bushing 44 and hence the outward force applied to balls 40 which presses them against holes 43. If screw 48 is turned so that the compression in spring 46 is increased, this increases the detent's breakaway force, and vice versa.

This selection of a supporting force for assembly 1 which is less than the rider's weight means assembly 1 can provide another important benefit to the rider, the benefit that assembly 1 performs as a suspension seat post. Since assembly 1 is only urged to remain in its extended position by its extended position supporting force rather than being “locked” in this position as in other “droppers”, the amount of force which assembly 1 can transmit upwardly to the rider through seat 19 as a result of the bicycle traveling over rough terrain is reduced from that which would be delivered by a fixed length seat post or a conventional dropper with a locking mechanism.

FIGS. 3 and 5 show seat post assembly 1 in its retracted position with pin 30 located at the top of slot 34 and with balls 40 located entirely within post 20; the detent is disengaged. It was described above how assembly 1, when in its extended position with its detent engaged, supplies the extended position supporting force for the rider. A downwardly directed force applied by the rider to seat 19 will be transmitted through clamp 18 and onto post 20, and a resulting downward axial component of this force urges post 20 to move downwardly with respect to sleeve 14. If this axial force is sufficient to overcome the extended position supporting force of assembly 1, it will cause post 20 to retract into sleeve 14. If this axial force is furthermore sufficient to overcome the supporting force supplied by the energy storage device of assembly 1 when at its retracted position, assembly 1 will move from its extended position shown in FIGS. 2 and 4 to its retracted position shown in these figures. If the rider wants assembly 1 to return back to its extended position, it is only necessary that he remove a sufficient portion of his weight from seat 19, for instance by standing on the bike's pedals, to allow the energy storage device of assembly 1 to return it to its extended position.

### Description—FIG. 6—Bicycle Seat Post Assembly, Second Embodiment

FIG. 6 shows a partially exploded view of an apparatus which is a second embodiment of this invention, a bicycle seat post assembly 51 which has two detents. Assembly 51 is similar to assembly 1 in that it also has sleeve 14 with hole 16 and sleeve 14 can be secured in seat tube 15, it has axis 12, and it has'seat clamp 18 which can secure seat 19 to the top of assembly 51. Assembly 51 further comprises the following items and features. Seat clamp 18 is secured to the top of a post 60 which is slidably inserted in sleeve 14 and a plug 62 is slidably inserted in post 60. With assembly 51 components properly positioned, a pin 70 with a hole 72 can be passed through hole 16 in sleeve 14, through a slot 74 in post 60, and into a hole 76 in plug 62, thereby limiting rotational and translational movement of post 60 relative to sleeve 14. Assembly 51 further comprises a spring 78 which is an energy storage device for assembly 51. Assembly 51 has an extended position detent which comprises an o-ring 80, an inner diametrical step in post 60 which in this case is an entrance 81 to post 60, a large diameter portion 82 of plug 62, a small diameter portion 83 of plug 62, a spring 86, and an adjustment screw 88 which is screwed into a threaded hole in plug 62. Assembly 51 also has an intermediate position detent comprising a pair of balls 90 which travel in a hole 92 in plug 62, a pair of holes 93 (one shown) in post 60, a ramp nut 94 which can travel in an axial hole 63 in plug 62, a spring 96, and an adjustment screw 98 which is screwed into ramp nut 94.

### Operation—FIGS. 6-12—Bicycle Seat Post Assembly, Second Embodiment

Bicycle seat 19, shown in FIG. 6, is not shown in FIGS. 7-12 in order to improve clarity in these figures. FIG. 7 shows bicycle seat post assembly 51 in an extended position wherein seat 19 is relatively far from sleeve 14 and seat tube 15 and FIG. 9 shows it in a retracted position wherein seat 19 is relatively near to them. FIG. 8 shows assembly 51 in a third position, an intermediate position between its extended position and its retracted position. FIGS. 10, 11, and 12 show in cross-section assembly 51 in the positions shown in FIGS. 7, 8, and 9 respectively. These figures provide operational details for assembly 51 which uses its extended position detent to urge assembly 51 to remain at its extended position and its intermediate position detent to urge assembly 51 to remain at its intermediate position. These figures and discussions thereon show how a rider can place assembly 51 in its different positions using hands-free operations. Friction is a consideration in the operation of the detents of assembly 51, but other sources of friction are relatively small and therefore can be ignored in this discussion.

The energy storage device of assembly 51, spring 78, provides a supporting force which urges post 60 to extend upwardly from sleeve 14 if there is a compression in spring 78. Spring 78 is shown as a coiled wire spring, and it has a spring rate. The urging of spring 78 at any position of post 60 relative to sleeve 14 has a magnitude which is the spring rate of spring 78 times its compression at that position. For instance, the extensional urging of spring 78 when assembly 51 is at its extended position is the spring rate of spring 78 times its compression when assembly 51 is at its extended position.

FIGS. 7 and 10 show assembly 51 in its extended position with pin 70 located at the bottom of slot 74. In this position, o-ring 80 of the extended position detent is against a shoulder on plug 62 and on the large diameter portion 82 of plug 62. O-ring 80 is partially outside of and pressed against an inner diametrical step in post 60, which in this case is the bottom entrance 81 to post 60. O-ring 80 is urged to remain on the large diameter portion 82 of plug 62 by a compression in spring 86 applied by adjustment screw 88 which is screwed into a threaded hole in the bottom of plug 62. The large diameter portion 82 of plug 62 forces o-ring 80 to have an outside diameter which is sufficiently large to prevent o-ring 80 from fully entering post 60, and therefore, when o-ring 80 is located on the large diameter portion 82 of plug 62, the extended position detent is engaged. In these figures, the intermediate position detent of assembly 51, discussed later, is disengaged.

A downward axial force applied to post 60 will urge post 60 with its entrance 81 to move downwardly with respect to sleeve 14, therefore urging o-ring 80 to move downwardly off the large diameter portion 82 of plug 62. Assuming no force is supplied by the energy storage device of assembly 51, an axial force just sufficient to move o-ring 80 off the large diameter portion of plug 82 and onto the small diameter portion 83, thereby allowing o-ring 80 to slide inside post 60 and thus disengaging the extended position detent, is the extended position detent's breakaway force. Therefore, assembly 51, when in its extended position with its extended position detent engaged, can support a rider with an extended position supporting force which includes a supporting force provided by its energy storage device, spring 78, when assembly 51 is in its extended position and the breakaway force of the extended position detent. Other than in the construction of their detents, assemblies 1 and 51 operate similarly when in their extended positions.

As in assembly 1, an extended position supporting force which is about 50-65% of the rider's weight works well for assembly 51. Adjustment of the extended position supporting force can be accomplished primarily in two ways. Firstly, the supporting force supplied by the energy storage device can be adjusted by changing the load in spring 78 when assembly 51 is in its extended position, either by changing the characteristics of spring 78, such as its spring rate and/or free length, or by changing its initial compression. Secondly, the extended position detent's breakaway force can be adjusted by turning screw 88 to change the compression of spring 86 and hence the force it applies to o-ring 80 to hold it on the large diameter portion 82 of plug 62. Turning screw 88 to increase the compression in spring 86 will increase the extended position detent's breakaway force, and vice versa.

FIGS. 8 and 11 show seat post assembly 51 in its intermediate position with pin 70 located at an intermediate position along slot 74. It was described above how assembly 51, when in its extended position with its extended position detent engaged, supplies the extended position supporting force for the rider. A downwardly directed force applied by the rider to seat 19 will be transmitted through clamp 18 and onto post 60, and a resulting downward axial component of this force urges post 60 to move downwardly with respect to sleeve 14. If this axial force is sufficient to overcome the extended position supporting force of assembly 51, it will cause post 60 to move downwardly with respect to sleeve 14. If this axial force is also sufficient to overcome the extensional urging of spring 78 when assembly 51 is in its intermediate position, assembly 51 will move to the intermediate position shown in these figures. These figures show o-ring 80 fully inside post 60, and therefore the extended position detent is disengaged. The intermediate position detent of assembly 51 is similar to the detent of assembly 1, both in construction and operation, and it is shown engaged in FIG. 11. In the intermediate position of assembly 51 shown in these figures, hole 92 in plug 62 is substantially in alignment with holes 93 in post 60. FIG. 11 shows balls 90 of the intermediate position detent of assembly 51 partially inserted into and pressing against holes 93, made possible by making holes 93 so they have a smaller diameter than that of balls 90. When balls 90 are in this position, the intermediate position detent is engaged. Balls 90 are urged to move outwardly and press against holes 93 by ramp nut 94 which is pulled downwardly by a compression in spring 96. Adjustment screw 98 is screwed into ramp nut 94, and the urging of balls 90 toward holes 93 can be adjusted by turning screw 98 to change the compression in spring 98 and hence the force it applies to ramp nut 94.

The intermediate position detent of assembly 51, when engaged as shown in FIGS. 8 and 11, can help support the rider. An axial force applied to post 60, urging it to move with respect to sleeve 14, will urge balls 90 to move inwardly along hole 92 in plug 62 and away from holes 93 in post 60. Assuming no force is supplied by the energy storage device of assembly 51, an axial force just sufficient to move balls 90 entirely within the inner diameter of post 60, thus fully disengaging the detent, is called the intermediate position detent's breakaway force. Assembly 51, therefore, in its intermediate position with its intermediate position detent engaged and with its extended position detent disengaged, can support the rider with an intermediate position supporting force which includes the supporting force provided by its energy storage device, spring 78, when assembly 51 is in its intermediate position and the breakaway force provided by the intermediate position detent.

When assembly 51 is in its intermediate position with its intermediate position detent engaged, the intermediate position detent of assembly 51, like its extended position detent, can support a portion of a rider's weight. But this intermediate position detent of assembly 51 also provides an additional benefit to the rider of the bicycle. In many cases, a rider wants to be “behind his seat”; he wants seat 19 to be in a low position and out of the way so he can readily get rearward of it and move side to side to improve his handling of the bicycle. As discussed above, when the intermediate position detent of assembly 51 is engaged, it urges assembly 51 to remain in its intermediate position and not retract. But the breakaway force of this detent works in both directions, in extension and in retraction; in other words, the intermediate position detent, when engaged, also urges assembly 51 to not extend. If the intermediate position detent's breakaway force is greater than the urge to extend provided by spring 78 when assembly 51 is in its intermediate position, then the intermediate position detent can hold assembly 51 in its intermediate position against the urging of spring 78 to extend assembly 51, even if the rider removes all his weight from seat 19. Therefore, the intermediate position detent of assembly 51 provides two benefits when engaged. Firstly, it provides a portion of the intermediate position supporting force described above, and secondly, with its breakaway force adjusted so that it is greater than the urge to extend provided by spring 78 when assembly 51 is at its intermediate position, the intermediate position detent can hold assembly 51 in its intermediate position even if the rider removes all his weight from seat 19.

FIGS. 9 and 12 show seat post assembly 51 in its retracted position with pin 70 is located at the top of slot 74 and with o-ring 80 and balls 90 entirely within post 60 wherein both detents of assembly 51 are disengaged. It was described above how assembly 51, when in its extended position with its extended position detent engaged, supplies the extended position supporting force for the rider and how a downwardly directed axial force greater than the extended position supporting force will cause post 60 to move downwardly with respect to sleeve 14. If this axial force is also sufficient to overcome the supporting force supplied by the energy storage device when assembly 51 is at its fully retracted position, assembly 51 will move from its extended position to its retracted position if post 60 can get past its intermediate position where that position's detent urges post 60 to stop. This can be accomplished by employing a couple of principles. The first principle is that the breakaway force of the intermediate position detent does not need to be very large. As in the case of the extended position detent of assembly 51, the breakaway force of the intermediate position detent can be adjusted so it is considerably less than the rider's weight. Also, as discussed above, in order to perform its function of preventing assembly 51 from extending from its intermediate position, the breakaway force of the intermediate position detent only needs to be slightly greater than the urge to extend provided by spring 78 when assembly 51 is in its intermediate position. The second principle concerns momentum. Downward movement of the rider, seat 19, and some components of assembly 51 results in a momentum due to their mass and velocity, and this momentum's available impulse helps overcome the urging of the intermediate position detent to stop post 60 at its intermediate position. Therefore, if the rider wants to move assembly 51 from its extended position to its retracted position, he first applies enough force to seat 19 to move assembly 51 from its extended position. Then he continues to apply a downwardly directed axial force, and this force and the momentum resulting from the movement of the rider, seat 19, and the components of assembly 51 which are moving with respect to sleeve 14, allow the rider to overcome the urging of the intermediate position detent to hold post 60 at its intermediate position and thus move assembly 51 to its retracted position.

With assembly 51 in its retracted position, the rider can remove some of his weight from the bicycle seat and allow post 60 to move upwardly with respect to sleeve 14. With proper removal of his weight, the rider can cause assembly 51 to move to its intermediate position and be held there by the intermediate position detent, or he can allow assembly 51 to extend to its extended position. If the rider wants assembly 51 to be held at its intermediate position, he can accomplish this by removing only a portion of his weight from the bicycle seat, causing assembly 51 to extend slowly. Therefore items which are moving upwardly with respect to sleeve 14, such as seat 19 and some components of assembly 51, have a momentum which is relatively small due to their slow speed. If this momentum is kept sufficiently small by the rider when assembly 51 is at its intermediate position, the intermediate position detent will engage and hold assembly 51 at that position against the extensional urging of spring 78. If the rider wants assembly 51 to move from its retracted position to its extended position, this can be accomplished if he removes a sufficient portion of his weight from seat 19 to allow spring 78 to extend assembly 51 relatively rapidly. In this case, the intermediate position detent will not be able to engage due to an impulse provided by a momentum resulting from the relatively rapid upward movement of some components of assembly 51 and seat 19 resulting from the extensional urging of spring 78.

In the operation of assembly 51, it is important to note the usefulness of its intermediate position with its detent as well as its retracted position. In almost any riding situation, it is relatively easy for a rider to apply more or less of his weight to seat 19. But in a racing or otherwise technical riding situation, the rider must almost always have both hands on the handlebars and therefore it is nearly impossible for the rider to actually pull up on seat 19 or any other part of assembly 51. In other words, when the intermediate position detent of assembly 51 is engaged and assembly 51 is held at its intermediate position, it cannot be assumed that the rider can apply an upward force to post 60 to release the intermediate position detent. By placing the intermediate position detent at the intermediate position but allowing assembly 51 to further retract from the intermediate position to the retracted position, this allows the rider to apply a downward force to release the intermediate position detent and move assembly 51 to its retracted position. In moving assembly 51 from its intermediate position to its retracted position, additional energy is stored in the energy storage device of assembly 51, namely spring 78. This additional energy can be used to provide an upward momentum to the upwardly moving parts of assembly 51 and seat 19. As discussed above, this momentum can be used to prevent the intermediate position detent from engaging as post 60 is moving upwardly with respect to sleeve 14 and thereby allowing spring 78 to continue moving post 60 past its intermediate position and on to its extended position. Therefore, a benefit of having the retracted and intermediate positions of assembly 51 is to allow the rider, using hands-free operations, to return assembly 51 to its extended position from its intermediate position where it was held by its intermediate position detent.

A prototype of assembly 51 which worked well for a rider having a weight of 68 kgf (150 pounds) was constructed with the following parameters. The prototype had an extended position, and it had an intermediate position and a retracted position in which post 60 was retracted into sleeve 14 a distance of 8.9 cm (3.5 inches) and 9.9 cm (3.9 inches) respectively from its extended position. Spring 78 was a coiled wire spring having a spring rate of 4.0 N/cm (2.3 pounds/inch) and a compression at the prototype's extended position wherein spring 78 supplied a supporting force at the extended position of about 89 N (20 pounds). The prototype had an extended position detent which used an o-ring 80 having a size 207 and a material 90A durometer nitrile. Spring 86 of the extended position detent was adjusted so that the extended position detent's breakaway force was about 285 N (65 pounds). Adding the supporting force of spring 78 at the extended position (89 N (20 pounds)) to the breakaway force of the extended position detent (285 N (65 pounds)) gives an extended position supporting force of the prototype of 374 N (85 pounds) which is about 57% of the rider's weight. Movement of the prototype from its extended position to its intermediate position and its retracted position caused the compression of spring 78 to increase by 8.9 cm (3.5 inches) and 9.9 cm (3.9 inches) respectively, so that spring 78 supplied a supporting force at the intermediate position and the retracted position of 6.3 N (28 pounds) and 6.5 N (29 pounds) respectively. The prototype had an intermediate position detent which had balls 90 which were made of steel with a diameter of 0.79 cm (0.312 inches) and which had holes 93 in post 60 with a diameter of 0.71 cm (0.281 inches). By turning screw 98 to change the compression in spring 96, the intermediate position detent's breakaway force was adjusted to about 7 N (31 pounds), making it slightly greater than the extensional urging of spring 78 when the prototype was at its intermediate position. This prototype supported the rider at the extended position with few “nuisance” retractions, it could be moved by the rider to its intermediate position and held there using the intermediate position detent, and it could be moved by the rider to its retracted position and then to its extended position, all movements being performed using hands-free operations.

### CONCLUSION, RAMIFICATIONS, AND SCOPE

Accordingly, the reader will see that the two embodiments presented are bicycle seat post assemblies which can be moved between an extended position to provide a rider with a relatively high seat height and a retracted position to provide him with a relatively low seat height. In these two assemblies, a detent is used to support a portion of the rider's weight when the assemblies are at their extended positions. In the second embodiment, the second assembly also has a detent at a position intermediate to the extended and retracted positions which can hold the second assembly in the intermediate position absent a force applied to the seat by the rider, but the rider, with an appropriate application and removal of forces to his seat, can position the second assembly in its retracted position and then allow it to return to its extended position. All movements of these assemblies can be performed by the rider using hands-free operations.

Although the description above contains many specificities, these should not be construed as limiting the scope of the invention but as merely providing illustrations of several embodiments. For instance, in the second embodiment, a third detent could be added at a second intermediate position. Also, in the second embodiment, the extended position detent could be of the same form as the intermediate position detent, namely one which uses balls instead of one which uses an o-ring as described. Also, the diametrical step in the extended position detent of the second embodiment is the entrance to its post, but other diametrical steps such as steps farther inside the post could also be used. Also, a detent which only uses one ball could be used. The scope of the invention should be determined by the appended claims and their legal equivalents rather than by the examples given.

I claim:

1. A seat post assembly which attaches a seat to a frame of a bicycle, the seat post assembly having an axis and comprising:
a sleeve which is attached to the frame of the bicycle,
a post to which the seat is attached slidably inserted in the sleeve so that, relative to the sleeve, the post has a first position in which the seat post assembly has a first length and a second position in which the seat post assembly has a second length which is shorter than the first length,
an energy storage device which urges the post to move from its second position to its first position,
and a detent which urges the post to be stationary with respect to the sleeve when the post is in its first position,
whereby the seat post assembly when at its first length provides a supporting force for a rider of the bicycle which includes the urging of the energy storage device and the urging of the detent,
and whereby the rider, by application of a force to the seat sufficient to overcome the supporting force, changes the seat post assembly's length from its first length to its second length using a hands-free operation.

2. The seat post assembly of claim 1 wherein the seat post assembly further comprises a plug slidably inserted in the post and fixed to the sleeve, and wherein the detent comprises the plug, a hole in the plug, a ball which travels in the hole in the plug, a hole in the post, and a spring which urges the ball to be located against the hole in the post when the post is in its first position, whereby the detent is engaged when the ball is urged toward and located against the hole in the post by the spring.

3. The seat post assembly of claim 2 wherein application by the rider of the force to the seat causes the ball to move against the urging of the spring and away from its location against the hole in the post, whereby the detent is disengaged.

4. The seat post assembly of claim 1 wherein the seat post assembly further comprises an inner diametrical step in the post and a plug slidably inserted in the post and fixed to the sleeve, the plug comprising a first portion with a first diameter and a second portion with a second diameter which is smaller than the first, and wherein the detent comprises the plug, the inner diametrical step in the post, an o-ring, and a spring which urges the o-ring to be located on the first portion of the plug at which location the o-ring has an outside diameter which substantially prevents its movement past the diametrical step in the post, and whereby, with the o-ring located against the inner diametrical step in the post and on the first portion of the plug, the detent is engaged.

5. The seat post assembly of claim 4 wherein the diametrical step in the post is an entrance to the post.

6. The seat post assembly of claim 4 wherein application by the rider of the force to the seat causes the o-ring to move against the urging of the spring from its location on the plug's first portion to a location on the plug's second portion in which location the o-ring has an outside diameter which allows its movement past the diametrical step in the post, whereby the detent is disengaged.

7. The seat post assembly of claim 1 wherein the energy storage device comprises a coiled spring.

8. The seat post assembly of claim 1 wherein the energy storage device is a gas spring comprising a cylinder and a piston.

9. The seat post assembly of claim 1 wherein the force applied to the seat by the rider results from an upward movement of the bicycle due to its travel over uneven terrain.

10. A seat post assembly which attaches a seat to a frame of a bicycle, the seat post assembly comprising:
a sleeve which is attached to the frame of the bicycle,
a post to which the seat is attached slidably inserted in the sleeve so that, relative to the sleeve, the post has a first position and a second position wherein the seat post assembly respectively has a first length and a second length which is shorter than the first length,
an energy storage device which urges the post to move from its second position to its first position,
a first detent which urges the post to be stationary with respect to the sleeve when the post is in its first position,
and a second detent which urges the post to be stationary with respect to the sleeve when the post is in its second position,
whereby the seat post assembly when at its first length provides to a rider of the bicycle a first supporting force which includes the urging of the energy storage device and the urging of the first detent, and when at its second length it provides to the' rider a second supporting force which includes the urging of the energy storage device and the urging of the second detent.

11. The seat post assembly of claim 10 wherein, with the post in its first position and with the first detent engaged, the rider applies a force to the seat sufficient to overcome the first supporting force whereby the rider causes the seat post assembly to change from its first length to a shorter length using a hands-free operation.

12. The seat post assembly of claim 10 wherein the urging of the second detent when the post is in its second position is greater than the urging of the energy storage device when the post is in its second position, whereby the detent holds the seat post assembly at its second length absent a force applied to the seat by the rider.

13. The seat post assembly of claim 12 wherein, with the post held at its second position by the second detent, the rider applies a force to the seat sufficient to overcome the second supporting force, whereby the rider moves the post from its second position to a third position wherein the seat post assembly has a third length which is shorter than the second length.

14. The seat post assembly of claim 13 wherein the energy storage device has sufficient urging to move the post from its third position to its second position with a speed at its second position which results in a momentum of the seat and components of the seat post assembly which are moving with respect to the sleeve which prevents engagement of the second detent.

15. The seat post assembly of claim 14 wherein the rider applies a sufficiently small force to the seat to allow the energy storage device to move the post from its third position, through its second position, and to its first position, thereby changing the seat post assembly's length from its third length to its first length using a hands-free operation.

16. A method used by a rider of a bicycle for changing a seat's position with respect to a bicycle frame to which the seat is attached using an apparatus comprising:
a sleeve which is attached to the frame of the bicycle,
a post to which the seat is attached which is slidably inserted in the sleeve so that, relative to the sleeve, the post has a first position in which the apparatus has a first length and a second position in which the apparatus has a second length which is shorter than the first,
an energy storage device which urge the post to move from its second position to its first position,
and a detent which urges the post to be stationary with respect to the sleeve when the post is in its first position,
the method comprising:
with the post at its first position, application by the rider of a force to the seat which is sufficient to overcome the urging of the energy storage device and the detent, wherein the post moves from its first position toward its second position,
and then application by the rider of a force to the seat which is sufficient to overcome the urging of the energy storage device wherein the post moves from its first position to its second position,
whereby the rider of the bicycle changes the apparatus from its first length wherein the seat has a first position with respect to the frame of the bicycle to its second length wherein the seat has a second position with respect to the frame of the bicycle.

17. The method of claim 16 further comprising, with the post at its second position, applying a force to the seat which is sufficiently small to allow the energy storage device to move the post from its second position to its first position, whereby the rider of the bicycle changes the apparatus from its second length wherein the seat has the second position with respect to the frame of the bicycle to its first length wherein the seat has the first position with respect to the frame of the bicycle.

18. The method of claim 16 wherein the apparatus further comprises a second detent which urges the post to be stationary with respect to the sleeve when the post is in its second position and wherein the urging of the second detent is greater than the urging of the energy storage device to move the post from its second position,
the method further comprising, after the rider has applied the force to the seat which moved the post to its second position, removing the force he applies to the seat,
whereby the second detent holds the apparatus at its second length absent a force applied to the seat.

19. The method of claim 18 wherein the apparatus further comprises a third position of the post relative to the sleeve in which the apparatus has a third length which is shorter than the second, the method further comprising, with the post at its second position and with the second detent engaged, application by the rider of a force to the seat which is sufficient to overcome the urging of the second detent and the energy storage device, thereby moving the post from its second position to its third position.

20. The method of claim 19 wherein the energy storage device, absent a force applied to the seat, has sufficient urging to move the post from its third position to its second position with a speed at its second position which results in a sufficient momentum of the seat and components of the apparatus which are moving with respect to the sleeve to prevent engagement of the second detent when the post is at its second position, the method further comprising, with the post at its third position, applying a force to the seat which is sufficiently small to allow the energy storage device to move the post from its third position, through its second position, and on to its first position, whereby the rider of the bicycle changes the apparatus from its third length wherein the seat has a third position with respect to the frame of the bicycle to its first length wherein the seat has the first position with respect to the frame of the bicycle.
